(19) United States
(12) Patent Application Publication
(10) Pub. No.: US 2011/0241855 A1
(43) Pub. Date: Oct. 6, 2011

(54) COMBINED MOTION /THERMAL DETECTION SYSTEM AND METHOD FOR A VEHICLE

(76) Inventors: KANDIS WEAVER, Apopka, FL (US); Joseph Moszczienski, Lake mary, FL (US)

(21) Appl. No.: 12/750,235

(22) Filed: Mar. 30, 2010

(51) Int. Cl. B60R 25/10

(52) U.S. Cl. 340/426.25

(57) ABSTRACT

A motion/thermal detection system and method for detecting the presence of a child or pet comprising: a detector where said detector includes a motion/thermal detection lens and provides a mechanism to detect motion and thermal activity over a range of space; a receiver to electronically collect the image passed thru the FOV lense; a processor within the detector, where said processor toggles the detector between a motion detection mode and a thermal detection mode via data acquired from the receiver; software residing on memory within the detector, said software capable of allowing the user to program the functions related to the detector; a mechanism to transmit an alert of the presence of a child or pet; and a power supply mechanism.

### BACKGROUND OF THE INVENTION

### 1. Field of Invention

The present invention relates to a motion/thermal detective system and method for a vehicle to detect the presence of a child or pet inadvertently left in a vehicle or unauthorized intrusion into a vehicle.

### 2. Description of Related Art

The hectic lives of parents and caretakers may lead to the unintended and dangerous circumstance where a child is left in a vehicle unattended. Many children when riding in a vehicle are placed in a child seat. Small infants many times fall asleep while riding in the vehicle after being placed in a child seat and therefore the parent or guardian who may be operating the vehicle may unintentionally forget that the child is in the vehicle. An unattended child left in a vehicle may lead to some tragic consequences. If the child is left in the car where the temperature of the vehicle may rise, the child could suffer serious injury or possibly death if left in the vehicle over a prolonged period of time. Many times the interior temperature of an enclosed vehicle may rise a number of degrees greater than the outdoor temperature due to the heat of the vehicle and the heat of the outdoor environment.

Also children may not be awake when the parent or guardian leaves the vehicle and due to the lack of any audible sound to alert the parent or guardian, the child may be unintentionally left in the vehicle. Devices have been developed in prior art to detect or to alert the parent or guardian that the child is being left inside of a vehicle and therefore helps to alleviate this problem. Many devices sound an audible alarm or send a signal to a receiver that alerts the parent of the unattended child in the vehicle. The devices of prior art operate both on motion and thermal detection of the child in the vehicle. Either a motion or a thermal system may be effective in alerting a parent of an unattended child. However it would be advantageous to have a combined system where both motion and/or thermal conditions can set off the alert and alert the parent of the unattended child in the vehicle. This device will also detect if an intruder has breached the interior of the vehicle by detecting his or her heat signature or movement and trigger the alarm.

### SUMMARY OF THE INVENTION

The present invention relates to a motion/thermal detection system for detecting the presence of a child, pet or intruder comprising: a detector where said detector includes a motion/thermal detection array and provides a means to detect motion and thermal activity over a range of space through a lense of suitable focal length and angle of view; a receiver collecting the thermal image passing thru the lense; a processor within the detector, where said processor toggles the detector between a motion detection mode and a thermal detection mode; software residing on memory within the detector, said software capable of allowing the user to program the functions related to the detector; a means to transmit an alert of the presence of a child, pet or intruder; and a power supply means.

The functions associated with the detection system may include the transmittal of an alert upon the detection of a child or pet, conditions for activation of the motion detection mode, a time period for motion detection mode, conditions for activation of the thermal detection mode, a time period for the thermal detection mode and toggle sequence between the motion detection mode and thermal detection mode. The means to transmit an alert may include transmitting the alert to either a receiver or a cell phone and initiating an audible alarm.

### BRIEF DESCRIPTION OF DRAWINGS

FIG. 1 provides a prospective view of the motion/thermal detection system according to the present invention.

FIG. 2 provides a flowchart of steps related to the motion/thermal detection system according to the present invention.

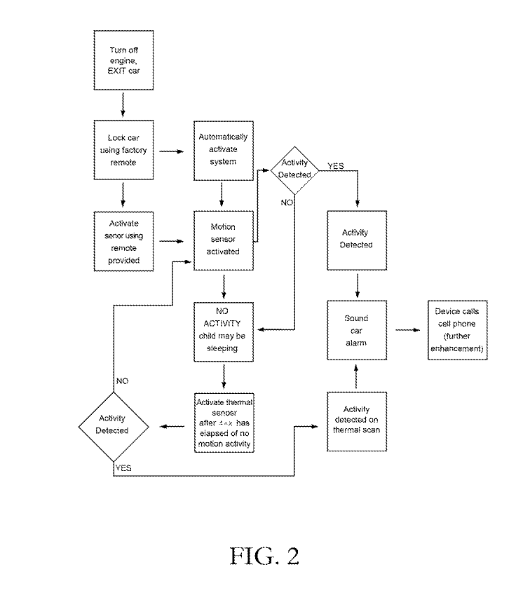

### DETAILED DESCRIPTION

The present invention relates to a motion/thermal detection system for a vehicle that is mounted in the interior of the vehicle to provide a means for detecting an unattended child within the vehicle. The system may be activated when the ignition of the vehicle is turned off or activated with a remote by the user. Once in the activation mode the motion/thermal detector initially goes into motion detection mode within the vehicle, after a period of inactivity the thermal detection is then activated to detect any thermal activity within the vehicle. The sequence allows for a consistent loop of detection that toggles between motion and thermal detection features of the system. The constant toggling effect of the system enables the system to consistently test for motion or thermal activity in the vehicle until the parent or guardian returns to the vehicle to resume travel therein.

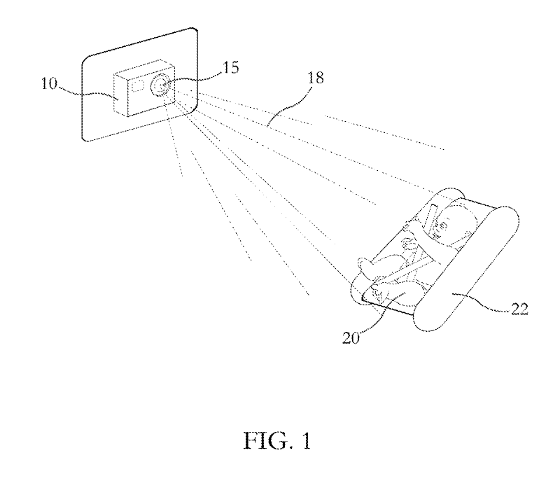

FIG. 1 provides a prospective view of the motion/thermal detection system according to the present invention. A motion/thermal Detector 10 depicted in FIG. 1 includes a Field of View Lens 15. The motion/thermal Detector 10 detects motion and thermal activity over a range of Space 18. The use of the motion/thermal Detector 10 is effective in detecting the presence of a Child 20 in a child Seat 22 as shown in FIG. 1. The child Seat 22 may be position in the rear seat of a vehicle and the motion/thermal Detector 10 is mounted within the interior of the vehicle in order to provide an effective means to detect the presence of the child.

The functional features and sequence of steps related to the Detector 10 provides some of the novel aspects of the present invention. The Detector 10 is activated upon the shutting down the ignition of the vehicle. Alternatively, the Detector 10 may be actively activated by a remote provided for the Detector 10. Alternatively the Detector 10 may be automatically activated upon the locking of the door using the remote locking device that is usually accompanying a vehicle. After being automatically activated the Detector 10 provides a motion detection sequence that is activated. If motion is detected an audible car alarm sounds and the detection device transmits a signal to a cellular phone that has been pre-selected as the receiver of the signal. The signal may be transmitted through a text message or a phone call via the wireless communication system. The Detector 10 includes sufficient software and communication components to activate such a sequence of events.

The Detector 10 is programmable by the user in order to provide a cell phone number or even a group of cell phone numbers that receive an alert that a child has been left unattended in the vehicle or a security breach of the vehicle has occurred. If the motion sensor does not activate indicating that no motion activity has been detected then the thermal sensor is activated after an elapsed period of time of no motion detection. This elapsed period of time is a set period of time and may be set at a range sufficient to provide a timely alert to the driver of the vehicle that an unattended child, pet or intruder is within the vehicle. If a thermal reading is detected the Detector 10 sounds the audible car alarm and then sends a cellular alert to a cell phone pre-designated in the Detector 10.

The Detector 10 may be powered and wired through the electrical system of the vehicle and also contain an internal battery backup to ensure that the Detector 10 has sufficient power to function. In addition to transmitting an alert through a wireless cell phone communication system the Detector 10 may also include Bluetooth technology where the device is synced with an audible alarm system equipped in the vehicle and/or a portable cell phone on the driver. This alternative provides at least two means of communication available for the Detector 10.

The motion/thermal protection system according to the present invention includes the use of suitable sensors to detect motion and thermal activity and alternative functional capabilities to alert the driver that a child, pet or intruder has been detected inside the vehicle. The positioning of the Detector 10 maybe is flexible enough so that it may function throughout the vehicle. Further use of the motion/thermal detection system according to present invention helps to alert and eliminate hazards associated with care-dependent passengers including children, pets and/or even handicapped individuals. The detector may be placed in a dome-type enclosure and placed at the headliner above the back seat or in another exemplary embodiment the detector may be mounted on the back of the front seat of a vehicle.

What is claimed is:

1. A motion/thermal detection system for detecting the presence of a child, pet or intruder comprising:
a. a detector where said detector includes a Field of View (FOV) lens and provides a means to direct detected motion and thermal activity over a range of space to a receiver;
b. a receiver to electronically process detect thermal motion images passing thru the FOV lense;
c. a processor within the receiver, where said processor toggles the receiver between a motion detection mode and a thermal detection mode;
d. software residing on memory within the detector, said software capable of allowing the user to program the functions related to the detector;
e. a means to transmit an alert of the presence of a child or pet; and
f. a power supply means.

2. The motion/thermal detection system according to claim 1, where the functions include transmittal of an alert upon the detection of a child, pet or intruder, conditions for activation of the motion detection mode, a time period for motion detection mode, conditions for activation of the thermal detection mode, a time period for the thermal detection mode and toggle sequence between the motion detection mode and thermal detection mode.

3. The motion/thermal detection system according to claim 1, where said means to transmit an alert includes transmitting the alert to at least one of a receiver and a cell phone and initiating an audible alarm.

4. The motion/thermal detection system according to claim 3, where said audible alarm includes a vehicle alarm.

5. The motion/thermal detection system according to claim 1, where said detector further includes Bluetooth technology as the means to transmit the alert.

6. The motion/thermal detection system according to claim 1, where said power supply means includes a battery within the detector.

7. A method of detecting the presence of a child, pet or intruder in a vehicle comprising the steps of:
a. activating a detector;
b. conducting a motion detection check over a range of space for a predetermined period of time;
c. sending an alert if motion is detected;
d. conducting a thermal activity check over a range of space for a predetermined period of time;
e. sending an alert if any thermal activity is detected; and
f. going back to through the sequence of steps b-e, until the detector is deactivated.
